(19) United States
(12) Patent Application Publication
(10) Pub. No.: US 2007/0128961 A1
(43) Pub. Date: Jun. 7, 2007

(54) Water-resistant fiberboard and a method of making such fiberboard

(76) Inventor: Brett Camp, Spring, TX (US)

Correspondence Address: JAMES H. RILEY II, 14781 MEMORIAL DR., # 160, HOUSTON, TX, 77079, US

(21) Appl. No.: 11/291,495

(22) Filed: Dec. 1, 2005

(51) Int. Cl. B32B 5/02; B32B 27/12

(52) U.S. Cl. 442/85; 442/286

(57) ABSTRACT

A water-resistant fiberboard can be made by using a combination of liner and polymer sheets that are laminated together to form the fiberboard. One or more polymer sheets are placed between the sheets of liner that form the fiberboard and these materials are laminated together. The liner/polymer fiberboard is extremely water-resistant and can be used to make a more water-resistant box.

### CROSS-REFERENCE TO RELATED APPLICATIONS

Not Applicable.

### STATEMENT REGARDING FEDERALLY SPONSORED RESEARCH

Not Applicable.

### REFERENCE TO MICROFICHE APPENDIX

Not Applicable.

### FIELD OF THE INVENTION

This invention relates to fiberboard and articles made from fiberboard, such as boxes or similar containers. More specifically, this invention relates to water-resistant fiberboard and its use to make containers.

### BACKGROUND OF THE INVENTION

Typically, fiberboard is made using sheets of liner (paper) that are glued together to form a rigid board. One of the most common uses for fiberboard is in the manufacturing of boxes that are used to hold various products. In some cases, the boxes need to be water-resistant because the products might be stored outside and subjected to the elements. For example, in the oilfield, a supplier of drill bits will ship the bit in a box that identifies the manufacturer of the bit and the type of bit. The service company in the field might put that box on the ground at the well site until it is needed. If the box is not water-resistant, the box will fall apart in a very short period of time. Therefore, box manufacturers have sought to make a box that is more water-resistant to satisfy the specific needs of certain customers.

U.S. Pat. No. 6,076,332, which is incorporated herein by reference, discloses one method of making a weather-resistant box using a vinyl substrate to cover the solid fiberboard. While the vinyl substrate does provide some water-resistance for the package material, it has been discovered that water still penetrates the fiberboard that forms the box. Thus, there still exists a need in the industry for a more water-resistant fiberboard to make a more water-resistant box.

### BRIEF SUMMARY OF THE INVENTION

It has been discovered that a water-resistant fiberboard can be made by using a combination of liner and polymer sheets that are laminated together to form the fiberboard. By putting one or more polymer sheets between the sheets of liner that form the fiberboard and laminating these materials together, the liner/polymer fiberboard becomes extremely water-resistant and can be used to make a more water-resistant box. Furthermore, in the manufacture of boxes, graphics can be printed directly on the fiberboard or can be printed on a sheet, such as vinyl, which is subsequently adhered to the fiberboard.

### BRIEF DESCRIPTION OF THE VIEWS OF THE DRAWINGS

Not Applicable.

### DETAILED DESCRIPTION OF THE INVENTION

It has been discovered that a water-resistant fiberboard can be made by using a combination of liner and polymer sheets that are laminated together to form the fiberboard. By putting one or more polymer sheets between the sheets of liner that form the fiberboard and laminating these materials together, the liner/polymer fiberboard becomes extremely water-resistant and can be used to make a more water-resistant box. Furthermore, in the manufacture of boxes, graphics can be printed directly on the fiberboard or can be printed on a sheet, such as vinyl, which is subsequently adhered to the fiberboard.

The preferred polymer sheet is a polyester film, such as Mylar®. Preferably, 2 mil Mylar with pressure sensitive adhesive (psa) is placed between the sheets of liner and the entire composition is laminated together to form the liner/polymer fiberboard. The polymer effectively insulates the liner from water and provides for a water-resistant fiberboard. The polymer sheet can also be placed on the outside of the liner to give additional water-resistance. This water-resistant fiberboard is ideal for manufacturing water-resistant boxes.

In the preferred embodiment, one sheet of 8# Mylar is sandwiched between two sheets of 67# wet strength liner to form a short stack. Two short stacks are glued together with PVA glue to form the pre-laminated fiberboard. As a further water barrier, one or both of the exterior liners can be covered with another polymer sheet, such as 14# Mylar. All of the components are then laminated together to form the liner/polymer fiberboard. This laminated fiberboard may be cut and stitched to form a water-resistant box.

In the case of box manufacturing, it is usually necessary to print graphics on one side of the fiberboard. Depending on the process used to create the graphics, the side receiving the graphics might not be covered with an exterior polymer sheet. For example, if the graphics is printed on vinyl as disclosed in U.S. Pat. No. 6,076,332, the vinyl would form the water-resistant layer on one side of the fiberboard so having an outside layer of polymer on that side would be unnecessary and might interfere with the adhesion of the vinyl to the fiberboard.

As described in its preferred embodiment, the liner/polymer fiberboard is a stack of materials consisting of a polymer sheet, a liner, a polymer sheet, another liner, PVA, a liner, a polymer sheet, another liner, and a polymer sheet (if needed). Obviously, there are other possible variations such as replacing the PVA with another polymer sheet, but the essential feature of this invention is the insertion of one or more polymer sheets between the sheets of liner to form an internal barrier to water. This invention provides multiple water-resistant layers to protect the liner and effectively creates a water-resistant fiberboard which is ideal for manufacturing a water-resistant box. This invention has other applications in areas where water resistance is desirable, such as, for example, as a moisture barrier in construction, signage, furniture, and office supplies.

The foregoing disclosure and description of the invention are illustrative and explanatory thereof, and various changes in the details of the illustrated method of operation may be made without departing from the spirit of the invention.

What I claim is:

1. A method for making water-resistant fiberboard comprising placing at least one polymer sheet between two sheets of liner and laminating the liner/polymer composite to form the fiberboard.

2. The method of claim 1 wherein the polymer sheet is polyester.

3. A method for making a water-resistant fiberboard box comprising placing at least one polymer sheet between two sheets of liner, laminating the liner/polymer composite to form fiberboard, and forming a box from the fiberboard.

4. The method of claim 3 wherein the polymer sheet is polyester.

5. A water-resistant fiberboard comprising at least one polymer sheet laminated between two sheets of liner.

6. The article of claim 5 wherein the polymer sheet is polyester.

7. A water-resistant box comprising fiberboard formed from at least one polymer sheet laminated between two sheets of liner.

8. The article of claim 7 wherein the polymer sheet is polyester.
